(19) United States
(12) Patent Application Publication
(10) Pub. No.: US 2022/0308818 A1
(43) Pub. Date: Sep. 29, 2022

(54) SCREEN WAKEUP METHOD, SCREEN WAKE-UP APPARATUS AND STORAGE MEDIUM

(71) Applicant: BEIJING XIAOMI MOBILE SOFTWARE CO., LTD., Beijing (CN)

(72) Inventor: Yongqiang JIA, Beijing (CN)

(73) Assignee: BEIJING XIAOMI MOBILE SOFTWARE CO., LTD., Beijing (CN)

(21) Appl. No.: 17/383,398

(22) Filed: Jul. 22, 2021

(30) Foreign Application Priority Data
Mar. 23, 2021 (CN) 202110308767.0

(51) Int. Cl. G06F 3/14; G06F 3/041; G06K 9/00; G06F 1/3234; G06F 1/3287

(52) U.S. Cl. CPC G06F 3/1423; G06F 3/041; G06K 9/00288; G06F 1/3265; G06F 1/3287

(57) ABSTRACT

A screen wake-up method includes: in response to determining a user performing a screen wake-up operation on the terminal, determining a first screen among the plurality of different screens; and waking up the first screen, and keeping other screens except for the first screen among the plurality of different screens in a non-wake-up state.

### CROSS-REFERENCE TO RELATED APPLICATION

This application claims priority to Chinese Patent Application No. 202110308767.0 field on Mar. 23, 2021, the disclosure of which is hereby incorporated by reference in its entirety.

### BACKGROUND

With the development of sciences and technologies, multi-screen terminals have become more and more popular due to their advantages in display functions. Taking a dual-screen mobile phone as an example, in addition to normal display of a main screen on the front side, the dual-screen mobile phone is also equipped with an auxiliary screen on the reverse side.

### SUMMARY

The present disclosure relates to the field of electronic technology, and in particular to a screen wake-up method, a screen wake-up apparatus and a storage medium.

According to a first aspect of the embodiments of the present disclosure, a screen wake-up method, which is applied to a terminal including a plurality of different screens. The screen wake-up method includes: in response to determining that a user has performed a screen wake-up operation on the terminal, determining a first screen among the plurality of different screens; and waking up the first screen, while keeping other screens except for the first screen among the plurality of different screens in a non-wake-up state.

According to a second aspect of the embodiments of the present disclosure, there is provided a screen wake-up apparatus, which is applied to a terminal including a plurality of different screens. The screen wake-up apparatus may include a determining unit configured to, in response to determining that a user is performed a screen wake-up operation on the terminal, determine a first screen among the plurality of different screens; and a waking-up unit configured to wake up the first screen, and keep other screens except for the first screen among the plurality of different screens in a non-wake-up state.

According to a third aspect of the embodiments of the present disclosure, there is provided a screen wake-up device. The screen wake-up device may include: a processor; and memory for storing instructions executable by the processor; wherein the processor is configured to perform the steps in the screen wake-up device described in any one of the above embodiments in the first aspect.

According to a fourth aspect, there is provided a computer-readable storage medium having computer programs stored thereon, and when the programs are executed by a processor, the steps in the screen wake-up device described in any one of the above embodiments in the first aspect are implemented.

It should be understood that the above general description and the following detailed description are only exemplary and explanatory, and are not intended to limit the present disclosure.

### BRIEF DESCRIPTION OF THE DRAWINGS

The drawings herein are incorporated into the specification and constitute a part of the disclosure, show embodiments consistent with the disclosure, and together with the specification are used to explain the principle of the disclosure.

FIG. 1 is a flowchart showing a screen wake-up method according to some embodiments.

FIG. 2 is a flowchart showing a method for determining a first screen among multiple different screens of a terminal according to some embodiments.

FIG. 3 is a schematic diagram showing a scene of waking up a terminal screen according to some embodiments.

FIG. 4 is a schematic diagram showing a scene of waking up a terminal screen according to some embodiments.

FIG. 5 is a flowchart showing a method for determining a first screen among multiple different screens of a terminal according to some embodiments.

FIG. 6 is a schematic diagram showing a scene of waking up a terminal screen according to some embodiments.

FIG. 7 is a flowchart showing a method for adjusting the first screen to a non-awake state according to some embodiments.

FIG. 8 is a flowchart showing a method for a terminal to perform a face recognition verification according to some embodiments.

FIG. 9 is a block diagram showing a screen wake-up apparatus according to some embodiments.

FIG. 10 is a block diagram showing a device for screen wake-up according to some embodiments.

### DETAILED DESCRIPTION

Various embodiments will be described in detail here, and examples thereof are shown in the accompanying drawings. When the following description refers to the accompanying drawings, unless otherwise indicated, the same numbers in different drawings represent the same or similar elements. The implementation manners described in the following exemplary embodiments do not represent all implementation manners consistent with the present disclosure. Rather, they are merely examples of apparatus and methods consistent with some aspects of the present disclosure as detailed in the appended claims.

A screen of a terminal can be woken up by detecting operations such as tapping performed by the user on the screen of the terminal. Such a method can be applied to screen wake-up of a single-screen terminal.

In some cases, the screen of the terminal can be determined and woken up by detecting related information of the terminal. For example, in a screen wake-up method, a touch operation performed by a user can be detected to determine that the terminal needs to perform a screen wake-up function, so as to wake up the screen of the terminal. For example, the user can wake up a screen of the terminal by “double-tapping” the screen. Wherein, the double-tapping operation includes, but is not limited to, the tapping operation of knuckles. In another screen wake-up method, by detecting a motion state of the terminal, it is determined that the terminal needs to perform the screen wake-up function, thereby waking up the screen of the terminal. For example, the user lifts a stationary terminal, and when the terminal, determines using an acceleration sensor that the current motion state of the terminal satisfies a preset condition for waking up the screen, the screen of the terminal is woken up. Through the above screen wake-up method, the screen of the terminal can be woken up when the user intends to wake up the screen of the terminal, thereby improving user experience.

However, these methods typically can only be applied to a single-screen terminal, and when it is applied to a multi-screen terminal, there will be a problem of lack of adaptation. For example, when the screen is woken up, all screens of the multi-screen terminal will be woken up, but the screen specified by the user among all the screens cannot be woken up alone. However, when all the screens of the multi-screen terminal are woken up, screens other than the screen intended to be used by the user will increase the electric energy consumption of the terminal, and the content of other screens may be exposed to other people's vision, which will cause the privacy of the user to be compromised.

A screen wake-up method provided by some embodiments of the present disclosure can be applied to a scene of waking up the terminal screen. Among them, the terminal may include dual-screen mobile terminals such as mobile phones, tablet computers, notebook computers, handheld computers, personal digital assistants (PDAs), portable media players (PMPs), navigation devices, wearable devices, smart bracelets and pedometers, and fixed terminals such as digital TVs and desktop computers.

In some embodiments of the present disclosure, a screen wake-up method can be provided to determine and wake up the screen designated by the user by detecting a screen wake-up operation performed by the user on the terminal and a operation area in which the screen wake-up operation is performed.

The screen wake-up method provided by various embodiments of the present disclosure can be applied to a terminal with multiple different screens. For ease of description, the screen designated by the user among the multiple different screens of the terminal is referred to as a first screen in the following.

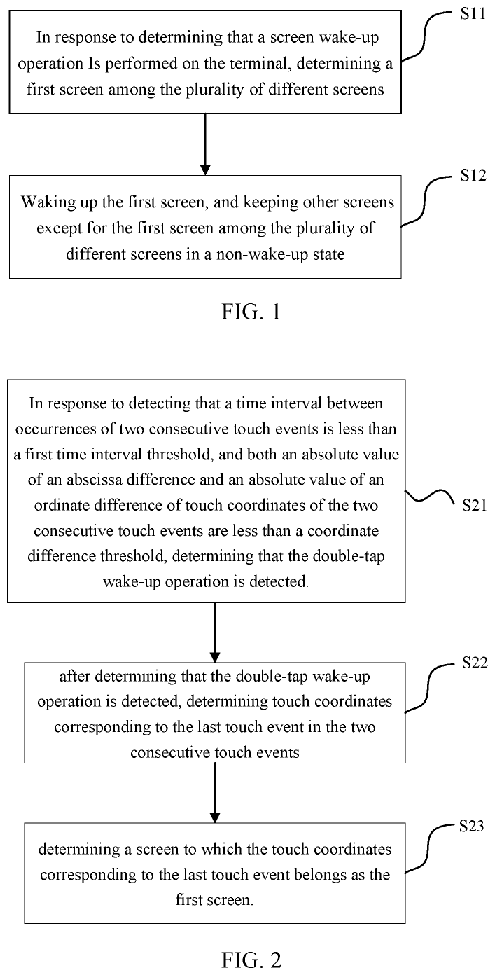

FIG. 1 is a flowchart showing a screen wake-up method according to some embodiments. As shown in FIG. 1, the screen wake-up method is applied in a terminal which includes a plurality of different screens, and includes the following steps.

In step S11, if it is determined that a screen wake-up operation is performed on the terminal by a user, a first screen is determined among the plurality of different screens.

In step S12, the first screen is woken up, and other screens expect for the first screen among the plurality of different screens are kept in a non-wake-up state.

In some embodiments of the present disclosure, by detecting the screen wake-up operation performed by the user on the terminal, the first screen can be determined and woken up among the plurality of different screens of the terminal, and other screens except the first screen can be kept in the non-wake-up state. By using the present disclosure, the power consumption of the terminal can be reduced, and the risk of leakage of user privacy can be reduced, thereby improving user experience.

In an example, for a terminal including a main screen on the front side (which is also called as a front main screen) and an auxiliary screen on the reverse side (which is also called as a reverse auxiliary screen), when the front main screen (i.e., the first screen) of the terminal is woken up, the reverse auxiliary screen of the terminal can be kept in the non-wake-up state. For another example, when the reverse auxiliary screen (i.e., the first screen) of the terminal is woken up, the front main screen of the terminal can be kept in a non-wake-up state.

In the screen wake-up method of the embodiment of the present disclosure, after the double-tap wake-up operation is detected, it can be determined that the user has performed the screen wake-up operation on the terminal.

In an example, after the double-tap wake-up operation is detected, a light sensor can be used to detect intensity of ambient light of the environment where the terminal is located, so as to determine whether the currently detected double-tap wake-up operation is a false trigger. In an example, the detected intensity of the ambient light can be compared with a preset ambient light intensity threshold. If it is determined that the detected intensity of the ambient light is greater than or equal to the ambient light intensity threshold (for example, the detected intensity of the ambient light is greater than or equal to 0), it is determined that the detected back tapping operation is not falsely triggered, and furthermore, it is determined that the user has performed a screen wake-up operation on the terminal. If it is determined that the detected intensity of the ambient light is less than the ambient light intensity threshold (for example, the detected intensity of the ambient light is less than 0), it is determined that the detected back tapping operation is a false trigger, and no more operation is performed. By using the present disclosure, power loss caused by false triggering can be prevented.

In some embodiments of the present disclosure, after a touch event triggered by a user on the terminal is detected, and the touch event meets a preset condition, it can be determined that the user has performed a double-tap to wake up the terminal. For example, it may be detected that a time interval between occurrences of two consecutive touch events is less than a first time interval threshold, and both an absolute value of an abscissa difference and an absolute value of an ordinate difference of touch coordinates of the two consecutive touch events are less than a coordinate difference threshold, it is determined that a double-tap wake-up operation is detected.

In an example, if it is determined that the user has performed a double-tapping operation to wake up the terminal, the first screen is determined among multiple different screens by using related parameters of triggering the touch events. For example, it may be detecting the touch coordinates corresponding to the touch events (for example, the touch coordinates corresponding to the last touch event), and determining a screen to which the touch coordinates belong is the first screen.

FIG. 2 is a flowchart showing a method for determining a first screen in a plurality of different screens of a terminal according to some embodiments. As shown in FIG. 2, the method includes the following steps.

In step S21, if it is detected that a time interval between occurring two consecutive touch events is less than a first time interval threshold, and both an absolute value of an abscissa difference and an absolute value of an ordinate difference of touch coordinates of the two consecutive touch events are less than a coordinate difference threshold, it is determined that a double-tap wake-up operation is detected.

In step S22, if it is determined that a double-tap wake up operation is detected, touch coordinates corresponding to the last touch event in two consecutive touch events are determined.

In step S23, a screen to which the touch coordinates corresponding to the last touch event belong is determined as the first screen.

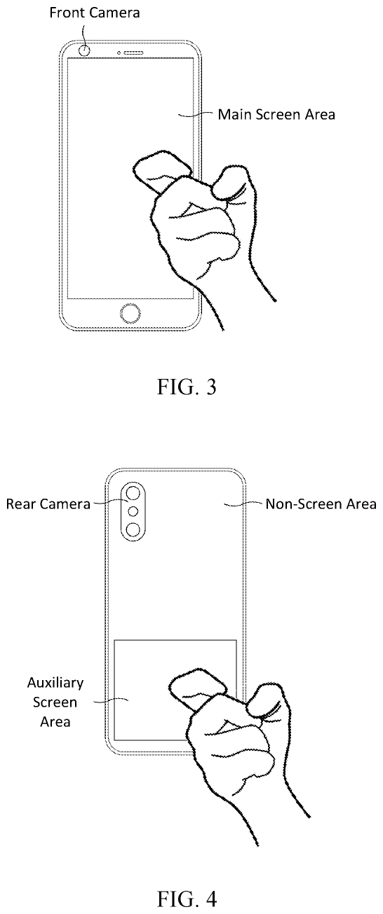

In an example, as shown in FIGS. 3 and 4, for a terminal equipped with a front main screen and a reverse auxiliary screen, the user can perform a touch operation on a main screen area of the front main screen and/or an auxiliary screen area of the reverse auxiliary screen, thereby triggering a touch event. When the user triggers touch events on the terminal for successive two times, the terminal can detect the touch events triggered by the user. When it is detected that the time interval between the occurrences of two consecutive touch events is less than a second time interval threshold (for example, 1 second), and both the absolute value of the abscissa difference and the absolute value of the ordinate difference of the touch coordinates of the two consecutive touch events are less than the coordinate difference threshold (for example, the absolute value of the coordinate difference is less than 20 pixels), it is determined that the user has performed a double-tap wake up operation on the terminal.

In the screen wake-up method provided by the embodiments of the present disclosure, by detecting touch events triggered by the user, it can be determined that the user has performed a screen wake-up operation on the terminal, so as to wake up the user-designated screen among multiple different screens of the terminal.

In some embodiments of the present disclosure, if it is detected that the user performs a back tapping operation on the terminal, it is determined that the user has performed a double-tap wake-up operation on the terminal. For example, when two consecutive back tapping operations are detected, and the time interval between the occurrences of the two consecutive back tapping operations is less than the second time interval threshold, it may be determined that the double-tap wake-up operation is detected.

In an example, if it is determined that the user has performed the double-tap wake-up operation, a face recognition component and/or an acceleration sensor are used to determine a screen that the user faces, and the screen that the user faces is determined as the first screen.

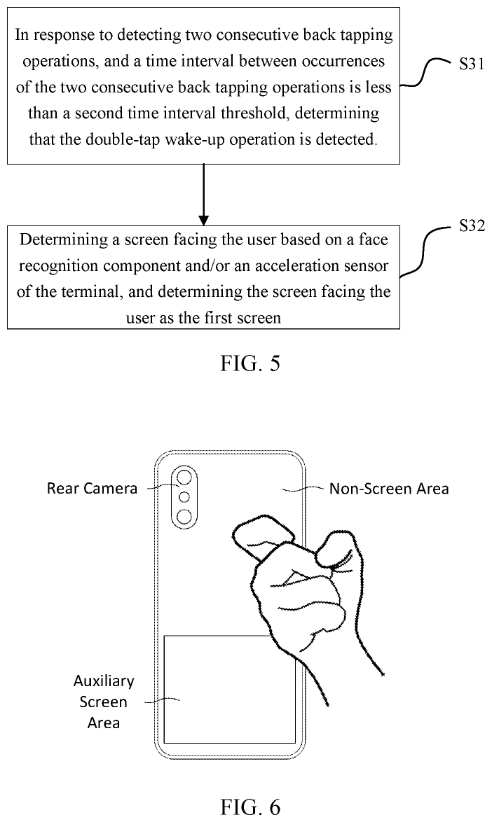

FIG. 5 is a flowchart showing a method for determining a first screen among multiple different screens of a terminal according to some embodiments. As shown in FIG. 5, the method includes the following steps.

In step S31, in response to detecting two consecutive back tapping operations on the terminal, and if the time interval between occurrences of the two consecutive back tapping operations is less than the second time interval threshold, it is determined that the double-tap wake-up operation is detected.

In step S32, the screen facing the user is determined based on a face recognition component and/or an acceleration sensor of the terminal, and the screen facing the user is determined as the first screen.

Wherein, the screen that the user faces includes a screen where the face recognition component is located, and/or a screen where the acceleration direction generated by the back tapping operation detected by the acceleration sensor is opposite.

In some embodiments, as shown in FIG. 6, for a terminal having a main screen installed on the front side and an auxiliary screen installed on the reverse side, the user can perform a back tapping operation in a non-screen area on the auxiliary screen of the reverse side (that is, tapping the non-screen area on the auxiliary screen of the reverse side). When the user triggers the back tapping operations for successive two times in the non-screen area of the auxiliary screen on the reverse side of the terminal, the terminal can detect the back tapping operations performed by the user by a sensing device such as an acceleration sensor. When it is detected that the time interval between occurrences of two consecutive back tapping operations is less than the second time interval threshold (for example, 1 second), it is determined that the user has performed a double-tap wake-up operation on the terminal.

In the embodiment of the present disclosure, after detecting that the user triggers the double-tap wake-up operation by the back tapping operations, the screen that the user is watching can be determined according to the acceleration sensor and/or the face recognition component, and the screen that the user is watching is determined as the first screen.

In one example, after detecting that the user triggers a double-tap wake-up operation through the back tapping operations, face recognition can be performed by using the face recognition component of the terminal. After facial data of the user is detected, the screen where the face recognition component obtaining the facial data of the user is located is determined as the first screen. For example, as shown in FIGS. 3 and 4, for a terminal with a front main screen and a reverse auxiliary screen, after detecting that the user triggers the double-tap wake-up operation through the back tapping operations, a front camera and a rear camera of the terminal are used to collect the facial data of the user. When the user's facial data is obtained through the front camera of the terminal, it is determined that the user is watching the front main screen where the front camera is located. Furthermore, the front main screen of the terminal is determined as the first screen. When the user's facial data is obtained through the rear camera of the terminal, it is determined that the user is watching the reverse auxiliary screen where the rear camera is located. Furthermore, the reverse auxiliary screen of the terminal is determined as the first screen.

In another example, after detecting that the user triggers the double-tap wake-up operation through the back tapping operations, the acceleration generated by the back tapping operation can be detected by the acceleration sensor of the terminal, and the screen opposite to an acceleration direction is determined as the first screen. For example, if the screen opposite to the acceleration direction is the front main screen of the terminal, it is determined that the user is watching the front main screen of the terminal. Furthermore, the front main screen of the terminal is determined as the first screen.

In an example, if a back tapping operation is detected, the ambient light of the environment where the terminal is located can be detected by the light sensor, and whether the back tapping operation is a false trigger is determined based on the detection result of the ambient light. For example, the detected intensity of the ambient light can be compared with the ambient light intensity threshold. If it is determined that the detected intensity is less than the ambient light intensity threshold (for example, the detected intensity of the ambient light is less than 0), it is determined that the detected back tapping operation is a false trigger, and no operation is performed. If it is determined that the detected intensity is greater than or equal to the ambient light intensity threshold (for example, the detected intensity of the ambient light is greater than or equal to 0), it is determined that the detected back tapping operation is not falsely triggered, and furthermore, it is determined that the user has performed a screen wake-up operation on the terminal. In an embodiment, after the first screen is determined and it is determined that the detected back tapping operation is not falsely triggered, the first screen may be woken up.

In the screen wake-up method provided by the embodiments of the present disclosure, it is possible to determine that the user has performed a screen wake-up operation on the terminal by detecting the user's back tapping operation on the terminal, so as to wake up the user-designated screen among multiple different screens of the terminal.

In the embodiment of the present disclosure, an interface displayed after waking up the first screen may be a lock screen interface of the terminal or an application desktop of the terminal. In an example, if the interface displayed after waking up the terminal is the lock screen interface of the terminal, the user can view the display content of the lock screen interface of the terminal by waking up the first screen. Among them, the displayed content can be content such as time, weather, and chat information. Of course, it can also be a static image, a dynamic image, and/or a video image set by the user. In another example, if the interface displayed after waking up the screen is the application desktop of the terminal, the user can perform operations such as opening an application on the application desktop of the terminal.

In the embodiment of the present disclosure, after the first screen is woken up, the first screen can be adjusted to a non-wake-up state in the case of no further operation performed by the user.

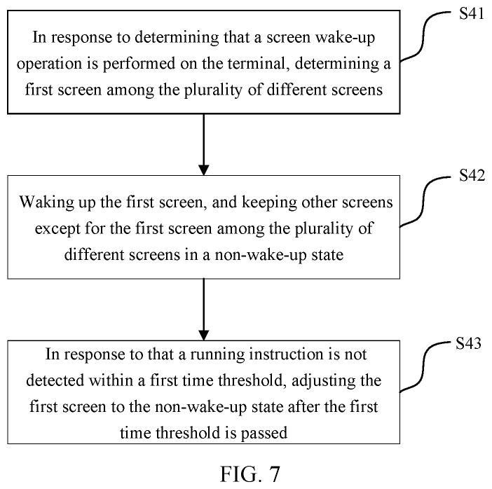

FIG. 7 is a flowchart showing a method for adjusting the first screen to a non-awake state according to some embodiments. As shown in FIG. 7, steps S41 and S42 in the screen wake-up method provided in FIG. 7 are similar to steps S11 and S12 in the method shown in FIG. 1, and will not be repeated here.

In step S43, if a running instruction is not detected within a first time threshold, the first screen is adjusted to the non-awake state after the first time threshold is passed.

In an example, the terminal is preset with the first time threshold (for example, 3 seconds) for detecting the running instruction, and if the running instruction is not detected within the first time threshold, the first screen is adjusted to the non-awake state. Through the execution of this example in the present disclosure, the power of the terminal can be further saved.

In the embodiment of the present disclosure, if the terminal has a face recognition function or is equipped with a face recognition function, after waking up the first screen, the face recognition authentication can be performed, and the camera on the same side as the first screen can be turned on for the face recognition.

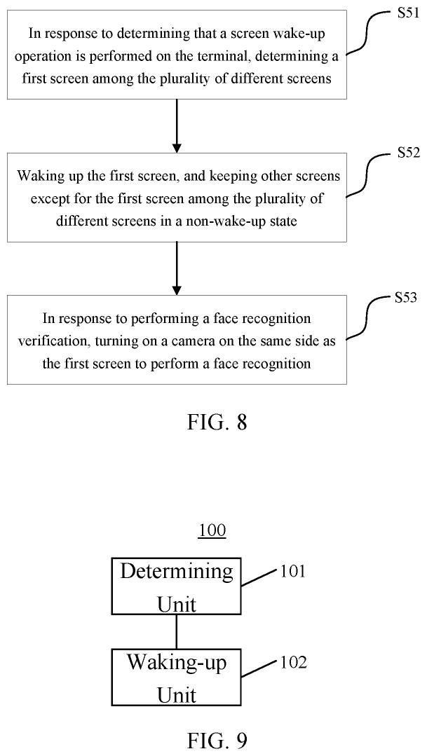

FIG. 8 is a flowchart showing a method for a terminal to perform a face recognition verification according to some embodiments. As shown in FIG. 8, steps S51 and S52 in the screen wake-up method provided in FIG. 8 are similar to steps S11 and S12 in the method shown in FIG. 1, and will not be repeated here.

In step S53, in response to performing the face recognition verification, the camera on the same side as the first screen is turned on to perform face recognition.

In an example, as shown in FIG. 3, if the first screen being woken up is the main screen of the terminal on the front side of the terminal, when the terminal performs the face recognition verification, the front camera of the terminal can be turned on to obtain current facial data of the user and perform face recognition. In another example, as shown in FIG. 4, if the first screen woken up is the auxiliary screen on the reverse side of the terminal, when the terminal performs the face recognition verification, the rear camera of the terminal can be turned on to obtain current facial data of the user and perform the face recognition. In some embodiments of the present disclosure, when the terminal performs face recognition verification, the camera on the same side as the wake-up screen can be turned on, so that the user can perform the face recognition verification more conveniently.

In some embodiments of the present disclosure, after detecting that the user performs a screen wake-up operation, a screen designated by the user can be determined and woken up among multiple different screens of the terminal according to the screen wake-up operation performed by the user. At the same time, non-user-designated screens are kept in the non-woken-up state. If the screen wake-up operation is determined by detecting the touch events, the touch coordinates that triggered the last touch event can be determined, and the screen to which the touch coordinates belong is determined as the first screen. If the screen wake-up operation is determined by detecting the back tapping operation, a screen facing the user can be determined by the acceleration sensor and/or the face recognition component, and the screen facing the user can be determined as the first screen. After waking up the first screen, the camera on the same side as the first screen can be called to perform the face recognition, and the first screen can be adjusted to the non-wake-up state after the running instruction is not detected within a preset time. The screen wake-up method provided by the present disclosure can wake up a screen designated by a user and turn on the camera on the side of the wake-up screen for the face recognition. In addition, the wake-up screen can be controlled to turn off the screen when the screen is woken up and the user has no further operation, thereby improving the user experience.

In an example, as shown in FIG. 3 and FIG. 4, for a terminal including a front main screen and a reverse auxiliary screen, when all screens of the terminal are in the non-wake-up state, the terminal can monitor the back tapping operation performed by the user and the touch event triggered by the user. For example, when the trigger time interval of two consecutive touch events is less than 1 second, and the absolute value of the abscissa difference and the absolute value of the ordinate difference of the trigger coordinates corresponding to the two touch events are both less than 20 pixels, it is determined that the user has performed a double-tap wake-up operation on the terminal. Then, the screen to which the trigger coordinates corresponding to the last touch event triggered belong can be determined. If the coordinates are located in the main screen area of the front main screen, the front main screen is woken up. If the terminal is equipped with a face unlock function, the front camera is turned on for the face recognition authentication. If the terminal is not equipped with the face unlock function, only the front main screen will be woken up without any other operation. If there is no further operation after the user wakes up the front main screen and the non-operation time reaches 3 seconds, the front main screen is controlled to be turned off (i.e., be adjusted to the non-wake-up state). If the coordinates are located in the auxiliary screen area of the reverse auxiliary screen, the reverse auxiliary screen will be woken up. If the terminal is equipped with a face unlock function, the rear camera is turned on for face recognition authentication. If the terminal is not equipped with the face unlock function, only the reverse auxiliary screen will be woken up and no other operation is performed. If there is no further operation after the user wakes up the reverse auxiliary screen and the non-operation time reaches 3 seconds, the reverse auxiliary screen is controlled to be turned off (i.e., be adjusted to the non-wake-up state). For another example, when the trigger time interval of two consecutive back tapping operations is less than 1 second, it is determined that the user has performed a double-tap wake-up operation on the terminal. Since the accuracy of the mechanism detecting the back tapping operation is low, false taps may occur in scenes such as the user walking. Therefore, in general, it is necessary to further collect ambient light intensity by using the light sensor. If it is determined that the ambient light intensity is 0, it is determined that the back tapping operation is a false trigger, and the terminal is controlled to not perform any operation. If it is determined that the ambient light intensity is not 0, the acceleration sensor and/or the face recognition component (such as a low-power camera) is used to determine the screen that the user is facing. If it is determined that the screen that the user is facing is the front main screen, the front main screen is woken up. If the terminal is equipped with a face unlock function, the front camera is turned on to perform face recognition verification. Otherwise, if the terminal is not equipped with the face unlock function, only the front main screen is woken up and no any other operation is performed. If there is no further operation after the user wakes up the front main screen, and the non-operation time reaches 3 seconds, the front main screen is controlled to be turned off (i.e., be adjusted to the non-wake-up state). If it is determined that the screen that the user is facing is the reverse auxiliary screen, the reverse auxiliary screen is woken up. If the terminal is equipped with a face unlock function, the rear camera is turned on for the face recognition authentication. If the terminal is not equipped with a face unlock function, only the reverse auxiliary screen is woken up and no other operation is performed. If there is no further operation after the user wakes up the reverse auxiliary screen, and the non-operation time reaches 3 seconds, the reverse auxiliary screen is controlled to be turned off (i.e., be adjusted to a non-wake-up state).

The screen wake-up method provided by the embodiments of the present disclosure can determine and wake up a user-designated screen among multiple different screens of the terminal.

Based on the same concept, embodiments of the present disclosure also provide a screen wake-up apparatus.

It can be understood that, in order to realize the above-mentioned functions, the screen wake-up apparatus provided in some embodiments of the present disclosure includes hardware structures and/or software modules corresponding to each function. In combination with the units and algorithm steps of the examples disclosed in some embodiments of the present disclosure, the embodiments of the present disclosure can be implemented in the form of hardware or a combination of hardware and computer software. Whether a certain function is executed by hardware or computer software-driven hardware depends on the specific application and design constraint conditions of the technical solution. Those skilled in the art can use different methods for each specific application to implement the described functions, but such implementation should not be considered as going beyond the scope of the technical solutions of the embodiments of the present disclosure.

FIG. 9 is a block diagram showing a screen wake-up apparatus according to some embodiments. Referring to FIG. 9, the apparatus 100 includes a determining unit or circuit 101 and a waking-up unit or circuit 102.

The determining unit or circuit 101 is configured to determine a first screen among the plurality of different screens, in the case that a user performed a screen wake-up operation on the terminal. The waking-up unit or circuit 102 is configured to wake up the first screen and keep other screens except for the first screen among the plurality of different screens in a non-wake-up state.

In some embodiments, the determining unit 101 is configured to determine that the screen wake-up operation is performed on the terminal in following manner: in response to detecting a double-tap wake-up operation, determining that the user has performed the screen wake-up operation on the terminal.

In some embodiments, the determining unit 101 is configured to detect a double-tap wake-up operation in following manner: in response to detecting that a time interval between occurrences of two consecutive touch events is less than a first time interval threshold, and both the absolute value of an abscissa difference and the absolute value of an ordinate difference of touch coordinates of the two consecutive touch events are less than a coordinate difference threshold, determining that the double-tap wake-up operation is detected.

In some embodiments, the determining unit 101 is configured to determine the first screen among the plurality of different screens in following manner: determining touch coordinates corresponding to the last touch event in the two consecutive touch events; and determining the screen to which the touch coordinates corresponding to the last touch event belongs as the first screen.

In some embodiments, the determining unit 101 is configured to detect the double-tap wake-up operation in following manner: in response to detecting two consecutive back tapping operations, and a time interval between occurrences of the two consecutive back tapping operations is less than a second time interval threshold, determining that the double-tap wake-up operation is detected.

In some embodiments, the determining unit 101 is configured to determine the first screen among the plurality of different screens in following manner: determining the screen facing the user based on a face recognition component and/or an acceleration sensor of the terminal, and determining the screen facing the user as the first screen. Wherein, the screen facing the user comprises a screen where the face recognition component is located, and/or a screen where an acceleration direction generated by the back-tapping operations detected by the acceleration sensor is opposite.

In some embodiments, the determining unit 101 further comprises a light sensor, and the determining unit 101 is configured to, in response to detecting the double-tap wake-up operation, determine that the screen wake-up operation is performed on the terminal in following manner: in response to detecting the double-tap wake-up operation, determining whether ambient light intensity detected by the light sensor is greater than or equal to an ambient light intensity threshold. When the ambient light intensity detected by the light sensor is greater than or equal to the ambient light intensity threshold, it is determined that the screen wake-up operation is performed on the terminal.

In some embodiments, the waking-up unit 102 is further configured to: after the first screen is woken up, in response to that a running instruction is not detected within the first time threshold, adjust the first screen to the non-wake-up state after the first time threshold is passed.

In some embodiments, the waking-up unit 102 is further configured to: after the first screen is woken up, in response to performing a face recognition verification, turn on a camera on the same side as the first screen to perform a face recognition.

Regarding the apparatus in the foregoing embodiment, the specific manner in which each module performs operation has been described in detail in the embodiment of the method, and detailed description will not be given here.

An embodiment of the present disclosure also proposes an electronic equipment, the electronic equipment includes:

a processor; and

memory for storing instructions executable by the processor;

wherein the processor is configured to perform the steps in the screen wake-up method according to any one of the foregoing embodiments.

An embodiment of the present disclosure also proposes a computer-readable storage medium having computer instructions stored thereon, and when the instructions are executed by a processor, the screen wake-up method according to any one of the foregoing embodiments is implemented.

Various embodiments of the present disclosure can have one or more of the following advantages.

If it is determined that a screen wake-up operation is performed on the terminal, the screen designated by the user is determined and woken up among a plurality of different screens of the terminal. In addition, keep non-user-designated screens in a non-awake state. Through the present disclosure, a single screen of a multi-screen terminal can be woken up, and power consumption can be saved.

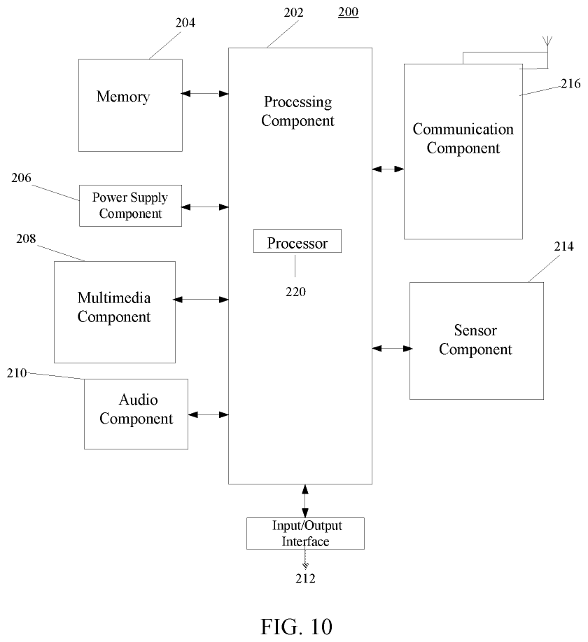

FIG. 10 is a block diagram showing a device for waking up a screen according to some embodiments. For example, the device 2100 may be a mobile phone, a computer, a digital broadcasting terminal, a message transceiving device, a game console, a tablet device, medical equipment, fitness equipment, a personal digital assistant, etc.

Referring to FIG. 10, the device 200 may include one or more of the following components: a processing component 202, memory 204, a power supply component 206, a multimedia component 208, an audio component 210, an input/output (I/O) interface 212, a sensor component 214, and a communication component 216.

The processing component 202 generally controls the overall operations of the device 200, such as operations associated with displaying, telephone calls, data communication, camera operations, and recording operations. The processing component 202 may include one or more processors 220 to execute instructions to complete all or part of the steps in the above method. In addition, the processing component 202 may include one or more modules to facilitate interaction between the processing component 202 and other components. For example, the processing component 202 may include a multimedia module to facilitate interaction between the multimedia component 208 and the processing component 202.

The memory 204 is configured to store various types of data to support operations at the device 200. Examples of these data include instructions for any application or method operating on the device 200, contact data, phone book data, messages, pictures, videos, etc. The memory 204 may be implemented by any type of volatile or non-volatile storage device or a combination thereof, such as static random access memory (SRAM), electrically erasable programmable read only memory (EEPROM), erasable programmable read only memory (EPROM), programmable read only memory (PROM), read only memory (ROM), magnetic memory, flash memory, magnetic disk or optical disk.

The power supply component 206 provides power to various components of the device 200. The power supply component 206 may include a power supply management system, one or more power supplies, and other components associated with generating, managing, and distributing power for the device 200.

The multimedia component 208 includes a screen that provides an output interface between the device 200 and the user. In some embodiments, the screen may include a liquid crystal display (LCD) and a touch panel (TP). In some embodiments, an organic light-emitting diode (OLED) can be employed.

If the screen includes a touch panel, then that screen may be implemented as a touch screen to receive input signals from the user. The touch panel includes one or more touch sensors, to sense touching, swiping, and gestures on the touch panel. The touch sensor may not only sense the boundary of the touching operation or swiping operation, but also detect the duration and pressure related to the touching operation or swiping operation. In some embodiments, the multimedia component 208 includes a front camera and/or a rear camera. When the device 200 is in an operation mode, such as a shooting mode or a video mode, the front camera and/or the rear camera may receive external multimedia data. Each of the front camera and rear camera may be a fixed optical lens system or have focal length and optical zoom capabilities.

The audio component 210 is configured to output and/or input audio signals. For example, the audio component 210 includes a microphone (MIC). When the device 200 is in an operation mode, such as a call mode, a recording mode, or a voice recognition mode, the microphone is configured to receive an external audio signal. The received audio signal may be further stored in the memory 204 or transmitted via the communication component 216. In some embodiments, the audio component 210 further includes a speaker for outputting audio signals.

The I/O interface 212 provides an interface between the processing component 202 and a peripheral interface module. The peripheral interface module may be a keyboard, a click wheel, a button, etc. These buttons may include, but are not limited to: home button, volume button, start button, and lock button.

The sensor assembly 214 includes one or more sensors for providing the status assessment of various aspects for the device 200. For example, the sensor component 214 can detect the on/off state of the device 200, and the relative positioning of the components. For example, the component is a display and a keypad of the device 200, and the sensor component 214 can also detect the position change of the device 200 or a component of the device 2100, the presence or absence of user contact with the device 200, the orientation or acceleration/deceleration of the device 200, and the temperature change of the device 200. The sensor assembly 214 may include a proximity sensor configured to detect the presence of nearby objects without any physical contact. The sensor assembly 214 may also include a light sensor, such as a CMOS or CCD image sensor, for use in imaging applications. In some embodiments, the sensor assembly 214 may also include an acceleration sensor, a gyro sensor, a magnetic sensor, a pressure sensor, or a temperature sensor.

The communication component 216 is configured to facilitate wired or wireless communication between the device 200 and other devices. The device 200 can access a wireless network based on a communication standard, such as Wi-Fi, 2G, or 3G, or a combination thereof. In some embodiments, the communication component 216 receives a broadcast signal or broadcast related information from an external broadcast management system via a broadcast channel. In some embodiments, the communication component 216 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology, and other technologies.

In some embodiments, the device 200 may be implemented by one or more application specific integrated circuits (ASICs), digital signal processors (DSPs), digital signal processing devices (DSPDs), programmable logic devices (PLDs), Field programmable gate array (FPGA), controller, microcontroller, microprocessor or other electronic components to execute the receiving method described in any of the above embodiments.

In some embodiments, there is also provided a non-transitory computer-readable storage medium including instructions, such as memory 204 including instructions, which can be executed by the processor 220 of the apparatus 200 to complete the above method. For example, the non-transitory computer-readable storage medium may be ROM, random access memory (RAM), CD-ROM, magnetic tape, floppy disk, optical data storage device, etc.

In some embodiments of the present disclosure, there is provided a screen wake-up method, which is applied to a terminal including a plurality of different screens. The screen wake-up method includes: in response to determining that a user is performed a screen wake-up operation on the terminal, determining a first screen among the plurality of different screens; and waking up the first screen, and keeping other screens except for the first screen among the plurality of different screens in a non-wake-up state.

In some embodiments of the present disclosure, determining that the user has performed the screen wake-up operation on the terminal may include in response to detecting a double-tap wake-up operation, determining that the screen wake-up operation is performed on the terminal.

In some embodiments of the present disclosure, detecting the double-tap wake-up operation may include in response to detecting that a time interval between occurrences of two consecutive touch events is less than a first time interval threshold, and the absolute value of an abscissa difference and the absolute value of an ordinate difference of touch coordinates of the two consecutive touch events are both less than a coordinate difference threshold, determining that the double-tap wake-up operation is detected.

In some embodiments of the present disclosure, determining the first screen among the plurality of different screens may include: determining touch coordinates corresponding to a last touch event in the two consecutive touch events; and determining a screen to which the touch coordinates corresponding to the last touch event belongs as the first screen.

In some embodiments of the present disclosure, detecting the double-tap wake-up operation may include: in response to detecting two consecutive back tapping operations, and a time interval between occurrences of the two consecutive back tapping operations is less than a second time interval threshold, determining that the double-tap wake-up operation is detected.

In some embodiments of the present disclosure, determining the first screen among the plurality of different screens may include: determining a screen facing the user based on a face recognition component and/or an acceleration sensor of the terminal, and determining the screen facing the user as the first screen. Wherein, the screen facing the user comprises a screen where the face recognition component is located, and/or a screen where an acceleration direction generated by the back tapping operations detected by the acceleration sensor is opposite.

In some embodiments of the present disclosure, the terminal further includes a light sensor, wherein in response to detecting the double-tap wake-up operation, determining that the screen wake-up operation is performed on the terminal may include: in response to detecting the double-tap wake-up operation, determining whether ambient light intensity detected by the light sensor is greater than or equal to an ambient light intensity threshold; and when the ambient light intensity detected by the light sensor is greater than or equal to the ambient light intensity threshold, determining that the screen wake-up operation is performed on the terminal.

In some embodiments of the present disclosure, after the first screen is woken up, the screen wake-up method further includes: in response to a running instruction not being detected within the first time threshold, adjusting the first screen to the non-wake-up state after the first time threshold is passed.

In some embodiments of the present disclosure, after the first screen is woken up, the screen wake-up method further includes: in response to performing a face recognition verification, turning on a camera on the same side as the first screen to perform a face recognition.

In some embodiments of the present disclosure, there is provided a screen wake-up apparatus, which is applied to a terminal including a plurality of different screens. The screen wake-up apparatus may include a determining unit configured to, in response to determining that a user is performed a screen wake-up operation on the terminal, determine a first screen among the plurality of different screens; and a waking-up unit configured to wake up the first screen, and keep other screens except for the first screen among the plurality of different screens in a non-wake-up state.

In some embodiments of the present disclosure, the determining unit is configured to determine that the screen wake-up operation is performed on the terminal in following manner: in response to detecting a double-tap wake-up operation, determining that the user has performed the screen wake-up operation on the terminal.

In some embodiments of the present disclosure, the determining unit is configured to detect a double-tap wake-up operation in following manner: in response to detecting that a time interval between occurrences of two consecutive touch events is less than a first time interval threshold, and the absolute value of an abscissa difference and the absolute value of an ordinate difference of touch coordinates of the two consecutive touch events are both less than a coordinate difference threshold, determining that the double-tap wake-up operation is detected.

In some embodiments of the present disclosure, the determining unit is configured to determine the first screen among the plurality of different screens in following manner: determining touch coordinates corresponding to a last touch event in the two consecutive touch events; and determining a screen to which the touch coordinates corresponding to the last touch event belongs as the first screen.

In some embodiments of the present disclosure, the determining unit is configured to detect the double-tap wake-up operation in following manner: in response to detecting two consecutive back tapping operations, and the time interval between occurrences of the two consecutive back tapping operations is less than a second time interval threshold, determining that the double-tap wake-up operation is detected.

In some embodiments of the present disclosure, the determining unit is configured to determine the first screen among the plurality of different screens in following manner: determining a screen facing the user based on a face recognition component and/or an acceleration sensor of the terminal, and determining the screen facing the user as the first screen. The screen facing the user comprises a screen where the face recognition component is located, and/or a screen where an acceleration direction generated by the back tapping operations detected by the acceleration sensor is opposite.

In some embodiments of the present disclosure, the determining unit further includes a light sensor, and the determining unit is configured to, in response to detecting the double-tap wake-up operation, determine that the screen wake-up operation is performed on the terminal in following manner: in response to detecting the double-tap wake-up operation, determining whether ambient light intensity detected by the light sensor is greater than or equal to an ambient light intensity threshold; and when the ambient light intensity detected by the light sensor is greater than or equal to the ambient light intensity threshold, determining that the screen wake-up operation is performed on the terminal.

In some embodiments of the present disclosure, after the first screen is woken up, the waking-up unit is further configured to: in response to that a running instruction is not detected within a first time threshold, adjust the first screen to the non-wake-up state after the first time threshold is passed.

In some embodiments of the present disclosure, after the first screen is woken up, the waking-up unit is further configured to: in response to performing a face recognition verification, turn on a camera on the same side as the first screen to perform a face recognition.

The various device components, units, circuits, blocks, or portions may have modular configurations, or are composed of discrete components, but nonetheless may be referred to as “modules,” “components” or “circuits” in general. In other words, the components, units, circuits, blocks, or portions referred to herein may or may not be in modular forms, and these phrases may be interchangeably used.

The various device components, units, blocks, portions, or modules may be realized with hardware, software, or a combination of hardware and software.

In some embodiments of the present disclosure, the terms “installed,” “connected,” “coupled,” “fixed” and the like shall be understood broadly, and can be either a fixed connection or a detachable connection, or integrated, unless otherwise explicitly defined. These terms can refer to mechanical or electrical connections, or both. Such connections can be direct connections or indirect connections through an intermediate medium. These terms can also refer to the internal connections or the interactions between elements. The specific meanings of the above terms In some embodiments of the present disclosure can be understood by those of ordinary skill in the art on a case-by-case basis.

In the description of the present disclosure, the terms “one embodiment,” “some embodiments,” “example,” “specific example,” or “some examples,” and the like can indicate a specific feature described in connection with the embodiment or example, a structure, a material or feature included in at least one embodiment or example. In some embodiments of the present disclosure, the schematic representation of the above terms is not necessarily directed to the same embodiment or example.

Moreover, the particular features, structures, materials, or characteristics described can be combined in a suitable manner in any one or more embodiments or examples. In addition, various embodiments or examples described in the specification, as well as features of various embodiments or examples, can be combined and reorganized.

In some embodiments, the control and/or interface software or app can be provided in a form of a non-transitory computer-readable storage medium having instructions stored thereon is further provided. For example, the non-transitory computer-readable storage medium can be a ROM, a CD-ROM, a magnetic tape, a floppy disk, optical data storage equipment, a flash drive such as a USB drive or an SD card, and the like.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more portions of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, drives, or other storage devices). Accordingly, the computer storage medium can be tangible.

The operations described in this disclosure can be implemented as operations performed by a data processing apparatus on data stored on one or more computer-readable storage devices or retracted from other sources.

The devices in this disclosure can include special purpose logic circuitry, e.g., an FPGA (field-programmable gate array), or an ASIC (application-specific integrated circuit). The device can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The devices and execution environment can realize various different computing model infrastructures, such as web services, distributed computing, and grid computing infrastructures.

A computer program (also known as a program, software, software application, app, script, or code) can be written in any form of programming language, including compiled or interpreted languages, declarative or procedural languages, and it can be deployed in any form, including as a stand-alone program or as a portion, component, subroutine, object, or other portion suitable for use in a computing environment. A computer program can, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more portions, sub-programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform actions by operating on input data and generating output. The processes and logic flows can also be performed by, and apparatus can also be implemented as, special purpose logic circuitry, e.g., an FPGA, or an ASIC.

Processors or processing circuits suitable for the execution of a computer program include, by way of example, both general and special purpose microprocessors, and any one or more processors of any kind of digital computer. Generally, a processor will receive instructions and data from a read-only memory, or a random-access memory, or both. Elements of a computer can include a processor configured to perform actions in accordance with instructions and one or more memory devices for storing instructions and data.

Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented with a computer and/or a display device, e.g., a VR/AR device, a head-mount display (HMD) device, a head-up display (HUD) device, smart eyewear (e.g., glasses), a CRT (cathode-ray tube), LCD (liquid-crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components.

The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any claims, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination.

Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

As such, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing can be utilized.

It is intended that the specification and embodiments be considered as examples only. Other embodiments of the disclosure will be apparent to those skilled in the art in view of the specification and drawings of the present disclosure. That is, although specific embodiments have been described above in detail, the description is merely for purposes of illustration. It should be appreciated, therefore, that many aspects described above are not intended as required or essential elements unless explicitly stated otherwise.

Various modifications of, and equivalent acts corresponding to, the disclosed aspects of the example embodiments, in addition to those described above, can be made by a person of ordinary skill in the art, having the benefit of the present disclosure, without departing from the spirit and scope of the disclosure defined in the following claims, the scope of which is to be accorded the broadest interpretation so as to encompass such modifications and equivalent structures.

It should be understood that “a plurality” or “multiple” as referred to herein means two or more. “And/or,” describing the association relationship of the associated objects, indicates that there may be three relationships, for example, A and/or B may indicate that there are three cases where A exists separately, A and B exist at the same time, and B exists separately. The character “I” generally indicates that the contextual objects are in an “or” relationship.

Moreover, the terms “first” and “second” are used for descriptive purposes only and are not to be construed as indicating or implying a relative importance or implicitly indicating the number of technical features indicated. Thus, elements referred to as “first” and “second” may include one or more of the features either explicitly or implicitly. In the description of the present disclosure, “a plurality” indicates two or more unless specifically defined otherwise.

Some other embodiments of the present disclosure can be available to those skilled in the art upon consideration of the specification and practice of the various embodiments disclosed herein. The present application is intended to cover any variations, uses, or adaptations of the present disclosure following general principles of the present disclosure and include the common general knowledge or conventional technical means in the art without departing from the present disclosure. The specification and examples can be shown as illustrative only, and the true scope and spirit of the disclosure are indicated by the following claims.

What is claimed is:

1. A screen wake-up method, which is applied to a terminal comprising a plurality of different screens, and the screen wake-up method comprising:
in response to determining a user performing a screen wake-up operation on the terminal, determining a first screen among the plurality of different screens; and
waking up the first screen, and keeping other screens except for the first screen among the plurality of different screens in a non-wake-up state.

2. The screen wake-up method according to claim 1, wherein the determining the user performing the screen wake-up operation on the terminal comprises:
in response to detecting a double-tap wake-up operation, determining that the screen wake-up operation is performed on the terminal.

3. The screen wake-up method according to claim 2, wherein the detecting the double-tap wake-up operation comprises:
in response to detecting that a time interval between occurrences of two consecutive touch events is less than a first time interval threshold, and both an absolute value of an abscissa difference and an absolute value of an ordinate difference of touch coordinates of the two consecutive touch events are less than a coordinate difference threshold, determining that the double-tap wake-up operation is detected.

4. The screen wake-up method according to claim 3, wherein the determining the first screen among the plurality of different screens comprises:
determining touch coordinates corresponding to a last touch event in the two consecutive touch events; and
determining a screen to which the touch coordinates corresponding to the last touch event belongs as the first screen.

5. The screen wake-up method according to claim 2, wherein the detecting the double-tap wake-up operation comprises:
in response to detecting two consecutive back tapping operations, and a time interval between occurrences of the two consecutive back tapping operations is less than a second time interval threshold, determining that the double-tap wake-up operation is detected.

6. The screen wake-up method according to claim 5, wherein the determining the first screen among the plurality of different screens comprises:
determining a screen facing the user based on a face recognition component and/or an acceleration sensor of the terminal, and determining the screen facing the user as the first screen;
wherein, the screen facing the user comprises a screen where the face recognition component is located, and/or a screen where an acceleration direction generated by the back tapping operations detected by the acceleration sensor is opposite.

7. The screen wake-up method according to claim 2, wherein the terminal further comprises a light sensor, and
wherein the in response to detecting the double-tap wake-up operation, determining that the screen wake-up operation is performed on the terminal comprises:
in response to detecting the double-tap wake-up operation, determining whether ambient light intensity detected by the light sensor is greater than or equal to an ambient light intensity threshold; and
when the ambient light intensity detected by the light sensor is greater than or equal to the ambient light intensity threshold, determining that the screen wake-up operation is performed on the terminal.

8. The screen wake-up method according to claim 1, wherein after the first screen is woken up, the screen wake-up method further comprises:
in response to that a running instruction is not detected within a first time threshold, adjusting the first screen to the non-wake-up state after the first time threshold is passed.

9. The screen wake-up method according to claim 1, wherein after the first screen is woken up, the screen wake-up method further comprises:
in response to performing a face recognition verification, turning on a camera on the same side as the first screen to perform a face recognition.

10. A screen wake-up device, which is applied to a terminal comprising a plurality of different screens, and the screen wake-up device comprising:
a processor; and
memory for storing instructions executable by the processor;
wherein the processor is configured to:
in response to determining that a user is performed a screen wake-up operation on the terminal, determine a first screen among the plurality of different screens; and
wake up the first screen, and keep other screens except for the first screen among the plurality of different screens in a non-wake-up state.

11. The screen wake-up device according to claim 10, wherein the processor is further configured to:
in response to detecting a double-tap wake-up operation, determine that the screen wake-up operation is performed on the terminal.

12. The screen wake-up device according to claim 11, wherein the processor is further configured to:
in response to detecting that a time interval between occurrences of two consecutive touch events is less than a first time interval threshold, and both an absolute value of an abscissa difference and an absolute value of an ordinate difference of touch coordinates of the two consecutive touch events are less than a coordinate difference threshold, determine that the double-tap wake-up operation is detected.

13. The screen wake-up device according to claim 12, wherein the processor is further configured to:
determine touch coordinates corresponding to a last touch event in the two consecutive touch events; and
determine a screen to which the touch coordinates corresponding to the last touch event belongs as the first screen.

14. The screen wake-up device according to claim 11, wherein the processor is further configured to:
in response to detecting two consecutive back tapping operations, and a time interval between occurrences of the two consecutive back tapping operations is less than a second time interval threshold, determine that the double-tap wake-up operation is detected.

15. The screen wake-up device according to claim 14, wherein the processor is further configured to:
determine a screen facing the user based on a face recognition component and/or an acceleration sensor of the terminal, and determining the screen facing the user as the first screen;
wherein, the screen facing the user comprises a screen where the face recognition component is located, and/or a screen where an acceleration direction generated by the back tapping operations detected by the acceleration sensor is opposite.

16. The screen wake-up device according to claim 11, wherein the terminal further comprises a light sensor, and the processor is configured to:
in response to detecting the double-tap wake-up operation, determine whether ambient light intensity detected by the light sensor is greater than or equal to an ambient light intensity threshold; and
when the ambient light intensity detected by the light sensor is greater than or equal to the ambient light intensity threshold, determine that the screen wake-up operation is performed on the terminal.

17. The screen wake-up device according to claim 10, wherein after the first screen is woken up, the processor is further configured to:
in response to that a running instruction is not detected within a first time threshold, adjust the first screen to the non-wake-up state after the first time threshold is passed.

18. The screen wake-up device according to claim 10, wherein after the first screen is woken up, the processor is further configured to:
in response to performing a face recognition verification, turn on a camera on the same side as the first screen to perform a face recognition.

19. A non-transitory computer-readable storage medium having instructions stored thereon, wherein when the instructions are performed by a processor of a terminal, a screen wake-up method is implemented by the terminal,
wherein the screen wake-up method is applied to the terminal comprising a plurality of different screens, and the screen wake-up method comprises:
in response to determining that a user is performed a screen wake-up operation on the terminal, determining a first screen among the plurality of different screens; and
waking up the first screen, and keeping other screens except for the first screen among the plurality of different screens in a non-wake-up state.

20. A mobile terminal implementing the screen wake-up method according to claim 1, comprising the plurality of different screens, wherein the mobile terminal is configured to wake up only one screen designated by the user among the plurality of different screens while keep non-user-designated screens among the plurality of different screens in a non-awake state, thereby reducing power consumption.
